(19) United States
(12) Patent Application Publication
(10) Pub. No.: US 2024/0320057 A1
(43) Pub. Date: Sep. 26, 2024

(54) Dynamic Container Resizing

(71) Applicant: International Business Machines Corporation, Armonk, NY (US)

(72) Inventors: Jonathan D. Dunne, Dungarvan (IE); Sahdevsinh P Zala, Cary, NC (US); Abhay Choudhary, Dublin (IE); Eduardo Aguiar Patrocinio, Apex, NC (US); Karim Ladouari, Rathnew (IE)

(73) Assignee: International Business Machines Corporation, Armonk, NY (US)

(21) Appl. No.: 18/125,229

(22) Filed: Mar. 23, 2023

(51) Int. Cl. G06F 9/50

(52) U.S. Cl. CPC G06F 9/5077; G06F 9/5005; G06F 2209/5019

(57) ABSTRACT

Using a regression analysis on first telemetry data of a container, an embodiment identifies a set of features predicting a resource usage of the container. The container comprises an executing application. Using a time series analysis of data of the set of features, an embodiment predicts a future resource usage of the container at a future time. The data of the set of features is extracted from second telemetry data of the container. At the future time according to the future resource usage, an embodiment adjusts a size of a resource available to the container.

### BACKGROUND

The present invention relates generally to a method, system, and computer program product for container management. More particularly, the present invention relates to a method, system, and computer program product for dynamic container resizing.

A container encapsulates an application as a single executable package of software that bundles application code together with all of the related configuration files, libraries, and dependencies required for the application to run. A containerized application is portable from one type of machine and operating system to another, improving deployment flexibility and allowing for rapid rescaling (e.g., adjusting resources or deploying additional instances of a containerized application) as demand and available resources change. A container orchestration platform automates the installation, scaling, and management of containerized workloads and services, including scaling containerized applications, rolling out new versions of applications, and providing monitoring, logging, and debugging functions. One example of a presently known container orchestration platform is Kubernetes. (Kubernetes is a registered trademark of the Linux Foundation in the United States and other countries.)

A containerized application uses resources. Some non-limiting examples of resources are processor cores, memory, and storage. For example, one containerized application might require 2 processor cores, 2 gigabytes of memory, and 40 gigabytes of hard disk storage to provide a desired response time or throughput.

### SUMMARY

The illustrative embodiments provide a method, system, and computer program product. An embodiment includes a method that identifies, using a regression analysis on first telemetry data of a container, a set of features predicting a resource usage of the container, the container comprising an executing application. An embodiment predicts, using a time series analysis of data of the set of features, a future resource usage of the container at a future time, the data of the set of features extracted from second telemetry data of the container. An embodiment adjusts, at the future time according to the future resource usage, a size of a resource available to the container.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for dynamic container resizing in accordance with an illustrative embodiment;

FIG. 3 depicts an example of dynamic container resizing in accordance with an illustrative embodiment;

FIG. 4 depicts a continued example of dynamic container resizing in accordance with an illustrative embodiment;

FIG. 5 depicts a flowchart of an example process for dynamic container resizing in accordance with an illustrative embodiment.

### DETAILED DESCRIPTION

The illustrative embodiments recognize that, while container orchestration platforms and other container management systems allow users to build and manage containerized application configurations, assigning appropriate resources to a container, or instantiating a container on a system with appropriate resources, remains difficult. Existing quota management tooling provides pre-defined resource sizing in the form of pre-defined sets of resources referred to as small, medium, or large. However, a pre-defined set of resources is not always well-matched to a containerized application's actual needs. For example, a deployment engineer might not know an application's actual resource needs, so might initially deploy an application using the small resource type. However, if the deployed application then underperforms, the engineer will have to manually reconfigure the application to a larger resource type. As another example, if an application being deployed is deemed to be too large for the small resource type, an intuitive choice would be to move to the next size up. However, the application may not actually need all of the resources available in the medium resource type, and allocating the medium level of resources when not required wastes money (because provisioned resources are typically paid for even if underutilized) and power (because provisioned resources consume power even if underutilized). A deployment engineer could manually reconfigure an over-resourced application to a smaller resource type, but in the absence of a performance problem or alert the manual reconfiguration might not actually be performed. Thus, the illustrative embodiments recognize that there is a need to more precisely allocate and adjust resources than using the existing small, medium, or large pre-defined packages.

The illustrative embodiments also recognize that the resource needs of a containerized application often change over time. For example, more transactions might be routed through an accounting system near the end of a month or quarter than at other times, or more reservations might be routed through an airline reservation system around major holidays. In addition, to avoid performance degradation due to an under-resourced application and avoid over-provisioning an application, resource changes should occur as close as possible to when they will actually be needed. Thus, the illustrative embodiments recognize that there is a need to adapt to changing resource needs, and anticipate those changing resource needs if possible.

The illustrative embodiments recognize that the presently available tools or solutions do not address these needs or provide adequate solutions for these needs. The illustrative embodiments used to describe the invention generally address and solve the above-described problems and other problems related to dynamic container resizing.

An embodiment can be implemented as a software application. The application implementing an embodiment can be configured as a modification of an existing container orchestration or container management system, as a separate application that operates in conjunction with an existing container orchestration or container management system, a standalone application, or some combination thereof.

Particularly, some illustrative embodiments provide a method that uses a regression analysis on first telemetry data of a container to identify a set of features predicting a resource usage of the container, uses a time series analysis of data of the set of features to predict a future resource usage of the container at a future time, and adjusts, at the future time according to the future resource usage, a size of a resource available to the container.

An application receives data of a container and a system on which the container is executing or intended to execute. One non-limiting example of data of a container is telemetry output by an executing container—for example the container's current processor, memory, and storage usage percentages, a rate at which a particular query is executed, a query run time, a number or rate of queries against a particular database, a number or rate of context switches, a number or rate of storage accesses, and the like. Another non-limiting example of data of a container is data in a container configuration file—for example whether a container accesses a shared resource, a role performed by a container or containerized application such as database access, a queuing application, an implementation of a hidden Markov model), a language in which a containerized application is written (e.g., C or C++), an operating system under which a containerized application executes, and the like. Container configuration files are often referred to as YAML files, because YAML is a human-readable data-serialization language often used for configuration files and in applications where data is being stored or transmitted. Non-limiting examples of data of a system on which the container is executing or intended to execute are the number and speed of processor cores in the system, how much memory and storage are in the system, a system's current processor, memory, and storage usage percentages, and the like.

An embodiment performs a regression analysis of the data of a container and a system on which the container (and one or more applications the container supports) is executing or intended to execute. An embodiment uses a result of the regression analysis to identify a set of features of telemetry data that predict a container's resource usage, as well as how data of the features is to be combined into a resource usage prediction. One embodiment uses a multiple linear regression analysis, which outputs a resource usage prediction equation in the form of y=m₁x₁+m₂x₂+ . . . +mₙxₙ+c, in which c is a constant, x₁ to xₙ denote each of the independent features, and the m variables are weights set according to a relative importance of each feature. One embodiment performs three regression analyses: one each for a container's processor usage, memory usage, and storage usage. For example, an embodiment might use results of the regression analysis to determine that a rate at which a particular database query is executed, a query run time, and a rate of queries against a particular database are all proportional to a container's processor usage, and thus are all features predicting a container's processor usage. Another embodiment performs three regression analyses (one each for a container's processor usage, memory usage, and storage usage) for a particular container type, and performs three additional regression analyses for another container type. For example, an embodiment might determine one set of features applicable to a container performing one role (e.g., database access) and another set of features applicable to a container performing another role (e.g., implementing a hidden Markov model). As another example, an embodiment might determine one set of features applicable to a container executing an application implemented in one programming language or executing under one operating system (e.g., C++) and another set of features applicable to a container executing an application implemented in another programming language or executing under another operating system (e.g., Python). (Python is a registered trademark of the Python Software Foundation in the United States and other countries.) Another embodiment performs additional regression analyses on additional resources of a container. Some non-limiting examples of additional regression analyses are the free space in a heap, if the container is executing an application under an operating system that uses a heap for memory management, and network statistics such as latency or available bandwidth. Techniques for performing a regression analysis and identifying a set of features from a regression analysis result are presently available.

An embodiment receives a second portion of data of a container and a system on which the container is executing or intended to execute, and uses a presently available technique to extract data of the set of features from the second portion of data. For example, if a rate at which a particular database query is executed, a query run time, and a rate of queries against a particular database are all features predicting a container's processor usage, an embodiment extracts data of these features from the second portion of data.

An embodiment uses current values of the data of the set of features to determine a current resource usage of the container. For example, if a rate at which a particular database query is executed, a query run time, and a rate of queries against a particular database are all features predicting a container's processor usage, an embodiment might use current values of each feature to determine a container's current processor usage.

An embodiment uses a time-series analysis on the data of the set of features to predict a future value for a feature in the set of features. For example, if the time-series analysis shows that a query run time exhibits a pattern of having one average value during the day and a lower average value at night, an embodiment might predict that the query run time will have the lower average value every night next week. An embodiment uses one or more predicted values for features in the set of features to predict a resource usage of the container at a future time. For example, if a query run time is predicted to be lower at night than during the day, and a rate of queries against a particular database is also predicted to be lower at night than during the day, an embodiment might predict that processor usage for the container will also be lower at night than during the day. Another embodiment uses a time-series analysis on resource usage data of the container to predict a resource usage of the container at a future time, without an intermediate feature prediction step. For example, if the time-series analysis shows that a container's processor usage exhibits a pattern of having one average value during the day and a lower average value at night, an embodiment might predict that the processor usage will have the lower average value every night next week.

An embodiment uses a current value of a container's resource usage to determine whether a size of a resource available to the container should be adjusted. To adjust a size of a resource, one embodiment expands or reduces a size of the resource (i.e., vertical scaling). For example, an embodiment might make an additional processor core available to a container or remove a processor core from those available to a container, or add or reduce the amount of memory or storage space available to a container. To adjust a size of a resource, another embodiment performs vertical scaling by replacing a current instance of the container with another instance with expanded or reduced resources. Techniques to use a container orchestration framework or other container management tool to adjust sizes of resources available to a container are presently available. To adjust a size of a resource, another embodiment instantiates a second container configured with resources the same size as those of the current container, and duplicates an application executing in the first container in the new container. As a result, two copies of the application are now executing in parallel, improving overall throughput. To adjust a size of a resource, another embodiment removes an instance of a container. Instantiating or removing a container is referred to as horizontal scaling.

One embodiment decides whether to scale horizontally or vertically based on a characteristic described in a container information file. For example, if a container accesses a resource shared with another container or group of containers (e.g., a database or shared storage implementation), adding an additional instance of an application executing in the parallel with an original instance, might result in contention for the shared resource, wasting execution time. However, if a container is not dependent on a shared resource, the parallel execution made possible by horizontal scaling can improve application performance more than vertical scaling does.

One embodiment includes a default setting to initially scale either horizontally or vertically. The embodiment analyzes resulting container resource usage in a manner described herein, and if the initial scaling type is unsuccessful at adjusting resource usage to meet a container's needs, the embodiment performs another container adjustment using the other scaling type. For example, if an embodiment's allocation of another processor core to a container provides insufficient, the embodiment might instantiate another copy of the container. Another embodiment learns from a result of a first scaling decision to improve future scaling decisions.

An embodiment uses a predicted value of a container's resource usage to determine whether, and when, an adjustment to a size of a resource available to the container should be adjusted in a manner described herein. For example, an embodiment might predict that a container's accesses to a financial database will spike on the last day of every month (as month-end financial reports are generated), thus increasing processor usage beyond a currently configured level. Thus, an embodiment plans to add additional processor cores to the container just before the last day of every month, then remove the additional processor cores once accesses to the financial database return to baseline. One embodiment produces a resizing plan for review by a human expert. Another embodiment implements the resizing plan automatically.

The manner of dynamic container resizing described herein is unavailable in the presently available methods in the technological field of endeavor pertaining to container resource management. A method of an embodiment described herein, when implemented to execute on a device or data processing system, comprises substantial advancement of the functionality of that device or data processing system in using a regression analysis on first telemetry data of a container to identify a set of features predicting a resource usage of the container, using a time series analysis of data of the set of features to predict a future resource usage of the container at a future time, and adjusting, at the future time according to the future resource usage, a size of a resource available to the container.

The illustrative embodiments are described with respect to certain types of containers, container data, system data, features, resources, computer languages, predictions, adjustments, instantiations, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

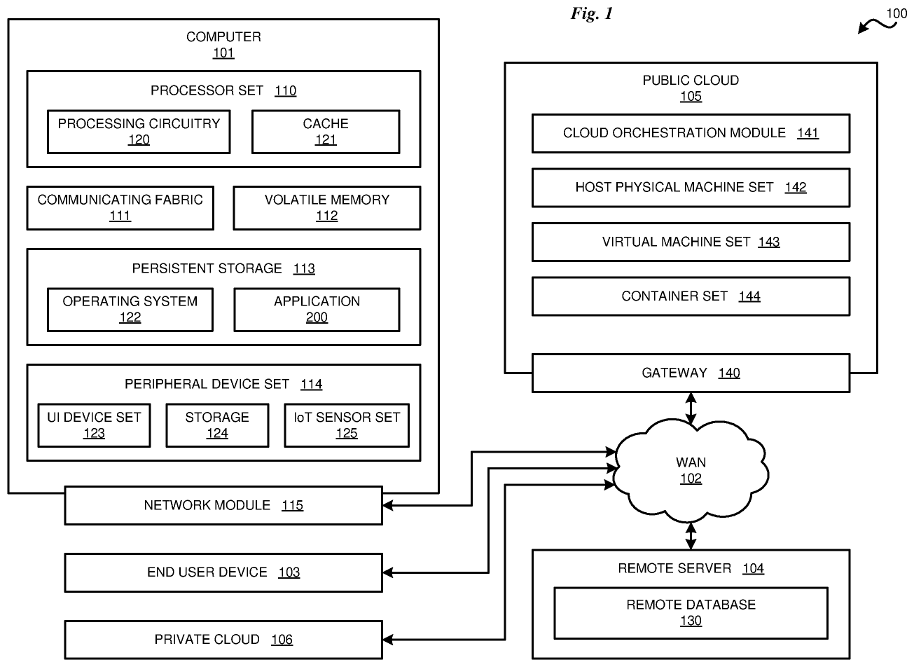

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a dynamic container resizing embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115.

Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

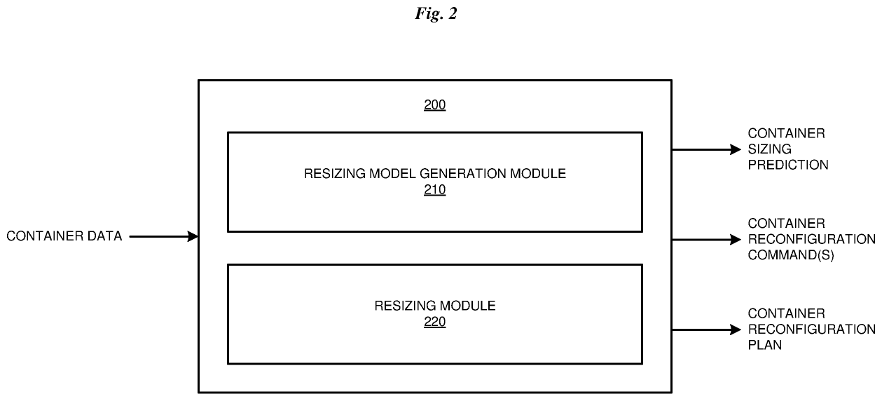

With reference to FIG. 2, this figure depicts a block diagram of an example configuration for dynamic container resizing in accordance with an illustrative embodiment. Application 200 is the same as application 200 in FIG. 1.

Application 200 receives data of a container and a system on which the container is executing or intended to execute. One non-limiting example of data of a container is telemetry output by an executing container—for example the container's current processor, memory, and storage usage percentages, a rate at which a particular query is executed, a query run time, a number or rate of queries against a particular database, a number or rate of context switches, a number or rate of storage accesses, and the like. Another non-limiting example of data of a container is data in a container configuration file—for example whether a container accesses a shared resource, a role performed by a container or containerized application such as database access, a queuing application, an implementation of a hidden Markov model), a language in which a containerized application is written (e.g., C or C++), an operating system under which a containerized application executes, and the like. Non-limiting examples of data of a system on which the container is executing or intended to execute are the number and speed of processor cores in the system, how much memory and storage are in the system, a system's current processor, memory, and storage usage percentages, and the like.

Resizing model generation module 210 performs a regression analysis of the data of a container and a system on which the container (and one or more applications the container supports) is executing or intended to execute. Module 210 uses a result of the regression analysis to identify a set of features of telemetry data that predict a container's resource usage, as well as how data of the features is to be combined into a resource usage prediction. One implementation of module 210 uses a multiple linear regression analysis, which outputs a resource usage prediction equation in the form of y=m₁x₁+m₂x₂+ . . . +mₙxₙ+c, in which c is a constant, x₁ to xₙ denote each of the independent features, and the m variables are weights set according to a relative importance of each feature. One implementation of module 210 performs three regression analyses: one each for a container's processor usage, memory usage, and storage usage. For example, module 210 might use results of the regression analysis to determine that a rate at which a particular database query is executed, a query run time, and a rate of queries against a particular database are all proportional to a container's processor usage, and thus are all features predicting a container's processor usage. Another implementation of module 210 performs three regression analyses (one each for a container's processor usage, memory usage, and storage usage) for a particular container type, and performs three additional regression analyses for another container type. For example, module 210 might determine one set of features applicable to a container performing one role (e.g., database access) and another set of features applicable to a container performing another role (e.g., implementing a hidden Markov model). As another example, module 210 might determine one set of features applicable to a container executing an application implemented in one programming language or executing under one operating system (e.g., C++) and another set of features applicable to a container executing an application implemented in another programming language or executing under another operating system (e.g., Python). Another implementation of module 210 performs additional regression analyses on additional resources of a container, such as the free space in a heap, if the container is executing an application under an operating system that uses a heap for memory management, and network statistics such as latency or available bandwidth.

Resizing module 220 receives a second portion of data of a container and a system on which the container is executing or intended to execute, and uses a presently available technique to extract data of the set of features from the second portion of data. For example, if a rate at which a particular database query is executed, a query run time, and a rate of queries against a particular database are all features predicting a container's processor usage, module 220 extracts data of these features from the second portion of data.

Module 220 uses current values of the data of the set of features to determine a current resource usage of the container. For example, if a rate at which a particular database query is executed, a query run time, and a rate of queries against a particular database are all features predicting a container's processor usage, module 220 might use current values of each feature to determine a container's current processor usage.

Module 220 uses a time-series analysis on the data of the set of features to predict a future value for a feature in the set of features. For example, if the time-series analysis shows that a query run time exhibits a pattern of having one average value during the day and a lower average value at night, module 220 might predict that the query run time will have the lower average value every night next week. Module 220 uses one or more predicted values for features in the set of features to predict a resource usage of the container at a future time. For example, if a query run time is predicted to be lower at night than during the day, and a rate of queries against a particular database is also predicted to be lower at night than during the day, module 220 might predict that processor usage for the container will also be lower at night than during the day. Another implementation of module 220 uses a time-series analysis on resource usage data of the container to predict a resource usage of the container at a future time, without an intermediate feature prediction step. For example, if the time-series analysis shows that a container's processor usage exhibits a pattern of having one average value during the day and a lower average value at night, module 220 might predict that the processor usage will have the lower average value every night next week.

Module 220 uses a current value of a container's resource usage to determine whether a size of a resource available to the container should be adjusted. To adjust a size of a resource, one implementation of module 220 expands or reduces a size of the resource (i.e., vertical scaling). For example, module 220 might made an additional processor core available to a container or remove a processor core from those available to a container, or add or reduce the amount of memory or storage space available to a container. To adjust a size of a resource, another implementation of module 220 performs vertical scaling by replacing a current instance of the container with another instance with expanded or reduced resources. Techniques to use a container orchestration framework or other container management tool to adjust sizes of resources available to a container are presently available. To adjust a size of a resource, another implementation of module 220 instantiates a second container configured with resources the same size as those of the current container, and duplicates an application executing in the first container in the new container. As a result, two copies of the application are now executing in parallel, improving overall throughput. To adjust a size of a resource, another implementation of module 220 removes an instance of a container. Instantiating or removing a container is referred to as horizontal scaling.

One implementation of module 220 decides whether to scale horizontally or vertically based on a characteristic described in a container information file. For example, if a container accesses a resource shared with another container or group of containers (e.g., a database or shared storage implementation), adding an additional instance of an application executing in the parallel with an original instance, might result in contention for the shared resource, wasting execution time. However, if a container is not dependent on a shared resource, the parallel execution made possible by horizontal scaling can improve application performance more than vertical scaling does.

One implementation of module 220 includes a default setting to initially scale either horizontally or vertically. The implementation analyzes resulting container resource usage in a manner described herein, and if the initial scaling type is unsuccessful at adjusting resource usage to meet a container's needs, the implementation performs another container adjustment using the other scaling type. For example, if module 220's allocation of another processor core to a container provides insufficient, module 220 might instantiate another copy of the container. Another implementation of module 220 learns from a result of a first scaling decision to improve future scaling decisions.

Module 220 uses a predicted value of a container's resource usage to determine whether, and when, an adjustment to a size of a resource available to the container should be adjusted in a manner described herein. For example, module 220 might predict that a container's accesses to a financial database will spike on the last day of every month (as month-end financial reports are generated), thus increasing processor usage beyond a currently configured level. Thus module 220 plans to add additional processor cores to the container just before the last day of every month, then remove the additional processor cores once accesses to the financial database return to baseline. One implementation of module 220 produces a resizing plan for review by a human expert. Another implementation of module 220 implements the resizing plan automatically.

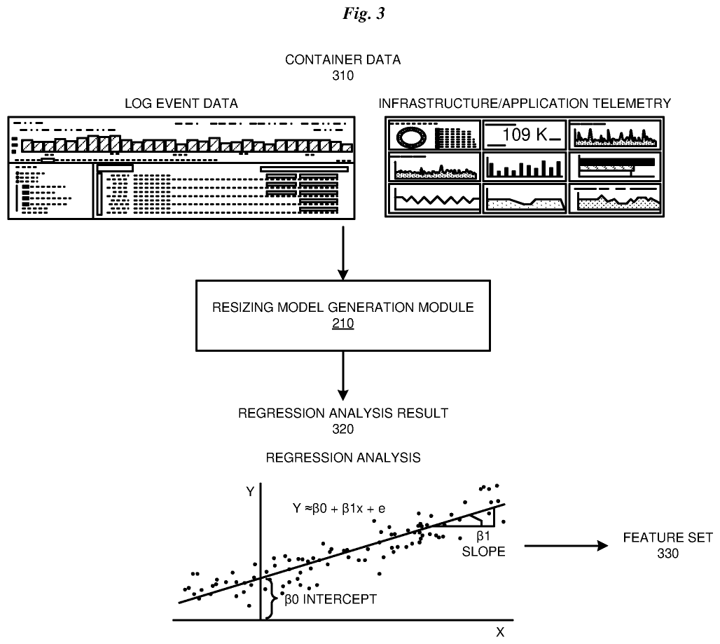

With reference to FIG. 3, this figure depicts an example of dynamic container resizing in accordance with an illustrative embodiment. Resizing model generation module 210 is the same as resizing model generation module 210 in FIG. 2. The example can be executed using application 200 in FIG. 2.

Resizing model generation module 210 receives container data 310, data of a container and a system on which the container is executing or intended to execute. Resizing model generation module 210 performs a regression analysis of container data 310, producing regression analysis result 320. Module 210 uses regression analysis result 320 to identify feature set 330, a set of features of telemetry data that predict a container's resource usage, as well as how data of the features is to be combined into a resource usage prediction.

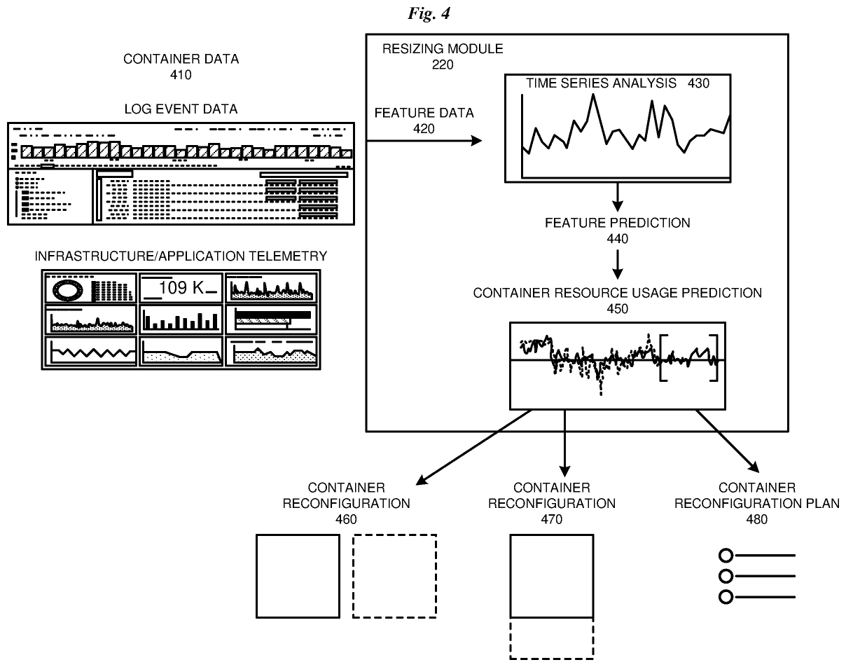

With reference to FIG. 4, this figure depicts a continued example of dynamic container resizing in accordance with an illustrative embodiment. Resizing module 220 is the same as resizing module 220 in FIG. 2. The example can be executed using application 200 in FIG. 2.

Resizing module 220 receives container data 410, a second portion of data of a container and a system on which the container is executing or intended to execute, and uses a presently available technique to extract feature data 420, data of the set of features from the second portion of data. Module 220 uses time-series analysis 430 on feature data 420 to predict feature prediction 440, a future value for a feature in the set of features. Module 220 uses one or more feature predictions 440 to predict container resource usage prediction 450.

Module 220 uses container resource usage prediction 450 to determine whether, and when, an adjustment to a size of a resource available to the container should be adjusted. In one option, module 220 implements container reconfiguration 470, in which module 220 expands or reduces a size of a resource (i.e., vertical scaling). In another option, module 220 implements container reconfiguration 460, in which module 220 instantiates a second container configured with resources the same size as those of the current container, and duplicates an application executing in the first container in the new container (i.e., horizontal scaling). In another option, module 220 produces container reconfiguration plan 480 for review by a human expert.

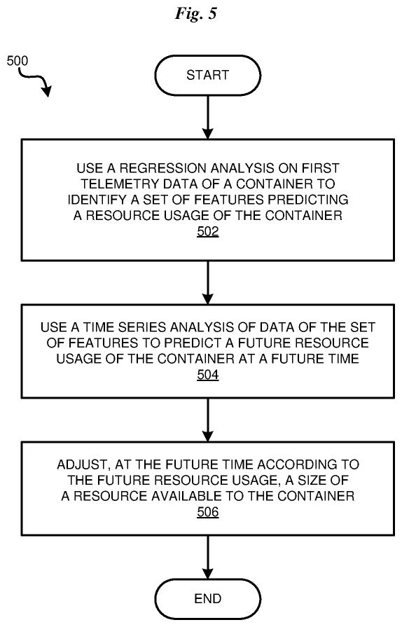

With reference to FIG. 5, this figure depicts a flowchart of an example process for dynamic container resizing in accordance with an illustrative embodiment. Process 500 can be implemented in application 200 in FIG. 2.

In block 502, the application uses a regression analysis on first telemetry data of a container to identify a set of features predicting a resource usage of the container. In block 504, the application uses a time series analysis of data of the set of features to predict a future resource usage of the container at a future time. In block 506, the application adjusts, at the future time according to the future resource usage, a size of a resource available to the container. Then the application ends.

Thus, a computer implemented method, system or apparatus, and computer program product are provided in the illustrative embodiments for dynamic container resizing and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
identifying, using a regression analysis on first telemetry data of a container, a set of features predicting a resource usage of the container, the container comprising an executing application;
predicting, using a time series analysis of data of the set of features, a future resource usage of the container at a future time, the data of the set of features extracted from second telemetry data of the container; and
adjusting, at the future time according to the future resource usage, a size of a resource available to the container.

2. The computer-implemented method of claim 1, wherein the set of features is specific to a role of the container.

3. The computer-implemented method of claim 1, wherein the set of features is specific to a computer language in which the executing application is implemented.

4. The computer-implemented method of claim 1, wherein the adjusting comprises expanding a size of a resource available to the container.

5. The computer-implemented method of claim 1, wherein the adjusting comprises reducing a size of a resource available to the container.

6. The computer-implemented method of claim 1, wherein the adjusting comprises instantiating a second container comprising a second instantiation of the executing application, the second container instantiated with second resource of the same size as the resource available to the container.

7. A computer program product comprising one or more computer readable storage medium, and program instructions collectively stored on the one or more computer readable storage medium, the program instructions executable by a processor to cause the processor to perform operations comprising:
identifying, using a regression analysis on first telemetry data of a container, a set of features predicting a resource usage of the container, the container comprising an executing application;
predicting, using a time series analysis of data of the set of features, a future resource usage of the container at a future time, the data of the set of features extracted from second telemetry data of the container; and
adjusting, at the future time according to the future resource usage, a size of a resource available to the container.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein the set of features is specific to a role of the container.

11. The computer program product of claim 7, wherein the set of features is specific to a computer language in which the executing application is implemented.

12. The computer program product of claim 7, wherein the adjusting comprises expanding a size of a resource available to the container.

13. The computer program product of claim 7, wherein the adjusting comprises reducing a size of a resource available to the container.

14. The computer program product of claim 7, wherein the adjusting comprises instantiating a second container comprising a second instantiation of the executing application, the second container instantiated with second resource of the same size as the resource available to the container.

15. A computer system comprising a processor and one or more computer readable storage media, and program instructions collectively stored on the one or more computer readable storage media, the program instructions executable by the processor to cause the processor to perform operations comprising:
identifying, using a regression analysis on first telemetry data of a container, a set of features predicting a resource usage of the container, the container comprising an executing application;
predicting, using a time series analysis of data of the set of features, a future resource usage of the container at a future time, the data of the set of features extracted from second telemetry data of the container; and
adjusting, at the future time according to the future resource usage, a size of a resource available to the container.

16. The computer system of claim 15, wherein the set of features is specific to a role of the container.

17. The computer system of claim 15, wherein the set of features is specific to a computer language in which the executing application is implemented.

18. The computer system of claim 15, wherein the adjusting comprises expanding a size of a resource available to the container.

19. The computer system of claim 15, wherein the adjusting comprises reducing a size of a resource available to the container.

20. The computer system of claim 15, wherein the adjusting comprises instantiating a second container comprising a second instantiation of the executing application, the second container instantiated with second resource of the same size as the resource available to the container.
